(19) United States
(12) Patent Application Publication
(10) Pub. No.: US 2012/0098356 A1
(43) Pub. Date: Apr. 26, 2012

(54) LINEAR MOTOR, BACK YOKE FOR LINEAR MOTOR, AND MANUFACTURING METHOD OF BACK YOKE

(75) Inventor: Kesatoshi TAKEUCHI, Shiojiri (JP)

(73) Assignee: SEIKO EPSON CORPORATION, Tokyo (JP)

(21) Appl. No.: 13/242,273

(22) Filed: Sep. 23, 2011

(30) Foreign Application Priority Data
Oct. 21, 2010 (JP) 2010-236331

(51) Int. Cl. H02K 41/02; H02K 15/00

(52) U.S. Cl. 310/12.24; 29/596

(57) ABSTRACT

A linear motor includes a slider unit having a magnet row in which plural permanent magnets are arranged in series so that the same poles are opposed to each other and moving in an arrangement direction of the magnet row by electromagnetic force, a stator unit in which the slider unit is inserted at an inner circumference side and electromagnetic coils for plural phases that receive supply of drive currents at different phases with respect to each phase are arranged along a movement direction of the slider unit, and a back yoke provided at an outer circumference side of the electromagnetic coils for plural phases in the stator unit, wherein plural slits along the movement direction of the slider unit for dividing a generation region of eddy currents into plural parts are formed in the back yoke.

### BACKGROUND

1. Technical Field

The present invention relates to a linear motor.

2. Related Art

As a motor, a linear motor that linearly moves a movable element relative to a stator using electromagnetic force is known Patent Document 1 (JP-A-2008-289344). In the motor, generally, by providing a back yoke outside of the stator, magnetic flux leakage is suppressed and magnetic efficiency is improved. Further, in the linear motor, magnetic flux is generated in a direction perpendicular to the movement direction of the movable element. Accordingly, in the case where the back yoke is provided for improvement of magnetic efficiency, eddy currents may be generated in the back yoke due to the magnetic flux and eddy-current loss may increase in the linear motor. In the past, it has not been sufficient to make efforts to address the problem.

### SUMMARY

An advantage of some aspects of the invention is to provide a technology of suppressing eddy-current loss in a linear motor.

### Application Example 1

This application example of the invention is directed to a linear motor including a slider unit having a magnet row in which plural permanent magnets are arranged in series so that the same poles are opposed to each other and moving in an arrangement direction of the magnet row by electromagnetic force, a stator unit in which the slider unit is inserted at an inner circumference side and electromagnetic coils for plural phases that receive supply of drive currents at different phases with respect to each phase are arranged along a movement direction of the slider unit, and a back yoke provided at an outer circumference side of the electromagnetic coils for plural phases in the stator unit, wherein plural slits along the movement direction of the slider unit for dividing a generation region of eddy currents into plural parts are formed in the back yoke.

According to the linear motor, the magnetic flux leakage to the outside is suppressed by the back yoke. Further, since the plural slits for fragmentation of the generation region of eddy currents are formed in the back yoke, the eddy-current loss in the linear motor is reduced.

### Application Example 2

This application example of the invention is directed to the linear motor according to application example 1, wherein the plural slits are respectively formed over the entire region in which the electromagnetic coils for plural phases are arranged when the stator unit is seen along a direction perpendicular to the movement direction of the slider unit.

According to the linear motor, since the plural slits are formed over the entire region in which the electromagnetic coils for plural phases are arranged, the generation region of eddy currents may be fragmented more reliably and the eddy-current loss in the linear motor may be further reduced.

### Application Example 3

This application example of the invention is directed to a back yoke used for a linear motor including a slider unit having a magnet row in which plural permanent magnets are arranged in series so that the same poles are opposed to each other and moving in an arrangement direction of the magnet row by electromagnetic force, and a stator unit in which the slider unit is inserted at an inner circumference side and electromagnetic coils for plural phases that receive supply of drive currents at different phases with respect to each phase are arranged along a movement direction of the slider unit. The back yoke is provided at an outer circumference side of the electromagnetic coils for plural phases in the stator unit, and has plural slits formed along the movement direction of the slider unit for dividing a generation region of eddy currents into plural parts.

Using the back yoke, the magnetic efficiency may be reduced while increase in the eddy-current loss in the linear motor is suppressed.

### Application Example 4

This application example of the invention is directed to a manufacturing method of a back yoke provided at an outer circumference side of electromagnetic coils for plural phases, used for a linear motor including a slider unit having a magnet row in which plural permanent magnets are arranged in series so that the same poles are opposed to each other and moving in an arrangement direction of the magnet row by electromagnetic force, and a stator unit in which the slider unit is inserted at an inner circumference side and the electromagnetic coils for plural phases that receive supply of drive currents at different phases with respect to each phase are arranged along a movement direction of the slider unit. The method includes (a) preparing a plate-like magnetic material member as a base material of the back yoke, and (b) forming plural slits that divide a region where eddy currents are generated into several parts when the linear motor is driven by scanning an outer surface of the magnetic material member along a direction corresponding to the movement direction of the slider unit using a laser beam.

According to the manufacturing method, the back yoke that can reduce the magnetic efficiency while suppressing increase in the eddy-current loss in the linear motor may be efficiently manufactured.

The application examples of the invention can be implemented in various forms and may be implemented in forms of a back yoke used for a linear motor and a manufacturing method and manufacturing equipment thereof, a linear motor using the back yoke, an actuator, a manipulator, a robot, a vehicle including the linear motor, or the like, for example.

### BRIEF DESCRIPTION OF THE DRAWINGS

The invention will be described with reference to the accompanying drawings, wherein like numbers reference like elements.

FIGS. 1A and 1B are schematic diagrams showing a configuration of a linear motor.

FIG. 2 is a schematic diagram for explanation of a configuration of a coil back yoke.

FIGS. 3A to 3D are explanatory diagrams for explanation of a manufacturing process of the coil back yoke.

FIGS. 4A and 4B are schematic diagrams showing other configuration examples of plural slits formed in the coil back yoke.

FIGS. 5A to 5D are schematic diagrams showing other configuration examples of the coil back yoke.

FIGS. 6A and 6B are schematic diagrams showing other configuration examples of the coil back yoke.

### DESCRIPTION OF EXEMPLARY EMBODIMENTS

### A. Embodiment

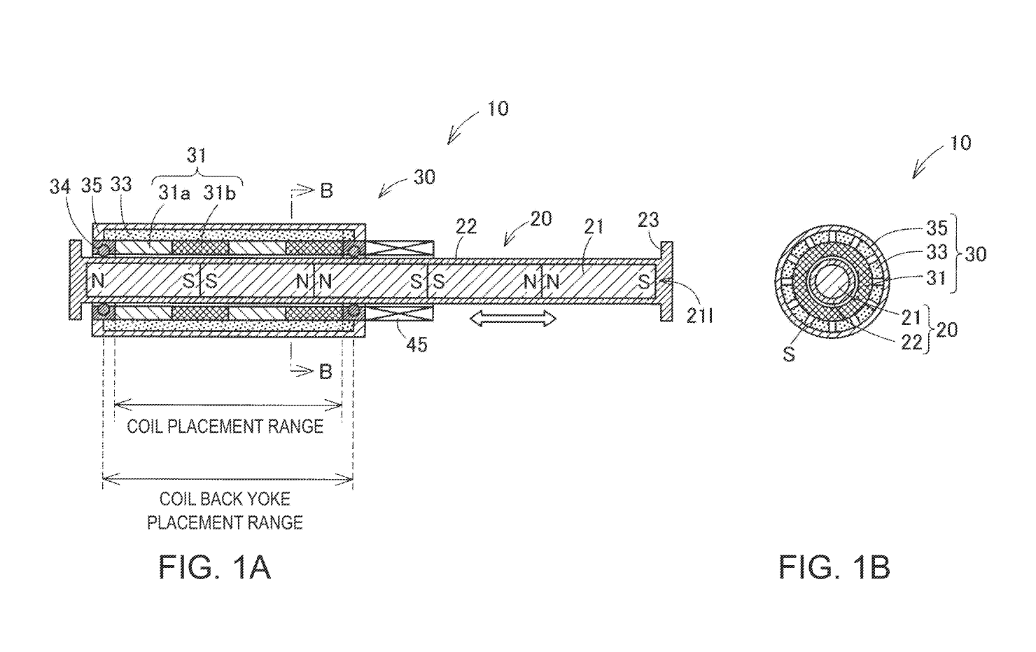

FIGS. 1A and 1B are schematic diagrams showing a configuration of a linear motor 10 as one embodiment of the invention. FIG. 1A is a schematic sectional view of the linear motor 10 seen from the side surface side. FIG. 1B is a schematic sectional view of the linear motor 10 along B-B section of FIG. 1A.

The linear motor 10 includes a movable element 20 in a nearly straight rod shape (also referred to as “slider 20”) and a stator 30 in a nearly cylindrical shape. The slider 20 is inserted into the stator 30 to reciprocate along the center axis direction of itself (shown by a hollow arrow).

The slider 20 includes a casing 22 in a nearly cylindrical shape with closed ends and a magnet row 211 contained within the casing 22. The magnet row 211 is a magnet device in which plural permanent magnets 21 are arranged in series so that the same poles may be opposed to each other. Note that, in FIG. 1A, “N”, “S” indicating an N-pole and an S-pole are shown with respect to each permanent magnet 21.

In the slider 20, according to the arrangement configuration of the permanent magnets 21, magnetic flux radially spreading in a direction perpendicular to the movement direction of the slider 20 (the arrangement direction of the permanent magnets 21) is formed at boundaries between end surfaces of the permanent magnets 21. In end parts of the slider 20, flange parts 23 projecting in the radial directions of the end surfaces are formed. The flange parts 23 function as stoppers for preventing the slider 20 from dropping off from the stator 30.

The stator 30 includes four electromagnetic coils 31, a coil back yoke 33, two shaft bearings 34, a casing 35, and a position detection part 45. The four electromagnetic coils 31 are arranged in series in the cylindrical direction to be adjacent to each other, and the slider 20 is inserted with an air gap at the inner circumference side of the coils. Note that the slider 20 is slidably held by the two shaft bearings 30 respectively provided in the opening parts at both ends of the four electromagnetic coils 31.

Here, the respective four electromagnetic coils 31 are divided into A-phase electromagnetic coils 31a and B-phase electromagnetic coils 31b to which currents at different phases are applied. In FIG. 1A, the A-phase electromagnetic coil 31a and the B-phase electromagnetic coil 31b are shown in distinction by different hatchings.

The A-phase electromagnetic coils 31a and the B-phase electromagnetic coils 31b are alternately arranged along the movement direction of the slider 20. Here, in the linear motor 10 of the embodiment, the arrangement pitch of the A-phase electromagnetic coils 31a and the B-phase electromagnetic coils 31b is nearly a half of the arrangement pitch of the permanent magnets 21 in the magnet row 211.

In the specification, the A-phase electromagnetic coil 31a on the left side of the paper is referred to as “first A-phase electromagnetic coil 31a” and the A-phase electromagnetic coil 31a on the right side of the paper is referred to as “second A-phase electromagnetic coil 31a”. Further, similarly, the B-phase electromagnetic coil 31b on the left side of the paper is referred to as “first B-phase electromagnetic coil 31b” and the B-phase electromagnetic coil 31b on the right side of the paper is referred to as “second B-phase electromagnetic coil 31b”.

The coil back yoke 33 is provided to cover the entire outer circumferential surfaces of the four electromagnetic coils 31, and improves the magnetic efficiency of the four electromagnetic coils 31. In the coil back yoke 33, plural slits S (FIG. 1B) for reducing eddy-current loss in the linear motor 10 are provided and their details will be described later.

It is preferable that the coil back yoke 33 is formed using a member with high magnetic permeability. The coil back yoke 33 may be formed using JNEX core or JNHF core of JFE Steel, for example. Here, “JNEX core” is a steel plate containing about 6.5% of silicon (Si). Further, “JNHF core” is a steel plate with different content ratios of Si in the thickness direction. Specifically, the content ratio of Si in the JNHF core may be about 6.5% in regions of about quarter thicknesses at both surface sides, and about 3.5% in the center thickness region sandwiched between the thickness regions.

The casing 35 is a container having a nearly cylindrical shape opening at the ends. In the internal space of the casing 35, the above described four electromagnetic coils 31, coil back yoke 33, and shaft bearings 34 are contained. Here, in the linear motor 10 of the embodiment, magnetic flux leakage is suppressed by the coil back yoke 33. Accordingly, even in the case where the casing 35 is formed using a conductive member, generation of eddy-currents in the casing 35 is suppressed. Therefore, according to the linear motor 10 of the embodiment, the casing 35 may be formed using a conductive material with a high coefficient of thermal conductivity (e.g., aluminum or the like), and the radiation effect in the linear motor 10 can be improved and its torque performance can be improved.

In the linear motor 10, the position detection part 45 is provided outside of one opening part of the casing 35. The position detection part 45 is provided to surround the outer circumference of the slider 20 and outputs a signal in response to a change of magnetic flux with the movement of the slider 20. The position detection part 45 may include a resolver, for example.

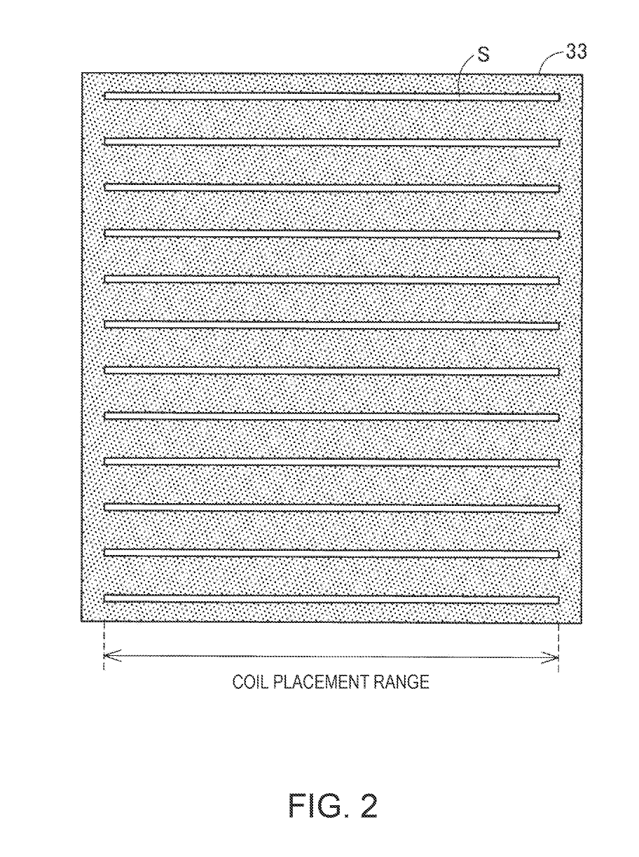

FIG. 2 is a schematic diagram showing a configuration of the coil back yoke 33 as a development view of the coil back yoke 33 developed in the circumferential direction. In the coil back yoke 33, plural parallel slits S extending in the center axis direction (in the horizontal direction of the paper) of the coil back yoke 33 are arranged at uniform intervals over the circumferential direction (in the vertical direction of the paper) of the coil back yoke 33. That is, in the coil back yoke 33, the plural slits S along a direction corresponding to the movement direction of the slider 20 are formed.

As described above, in the slider 20, the magnetic flux radially extending in the direction perpendicular to the movement direction of the slider 20 is formed at the boundaries between the permanent magnets 21 in the magnet row 211. Due to the magnetic flux, eddy currents are generated in the coil back yoke 33. That is, in the linear motor 10, the larger the magnetic flux density in the magnet row 211, the further the eddy-current loss increases.

However, using the coil back yoke 33 with the plural slits S formed, the eddy currents generated in the coil back yoke 33 due to the changes of magnetic fields by the electromagnetic coils 31 and the slider 20 may be distributed and fragmented with respect to each region between the slits S. Therefore, the eddy-current loss in the linear motor 10 may be reduced and the drive efficiency of the linear motor 10 may be improved.

Here, the range in which the coil back yoke 33 is placed when the stator 30 (FIGS. 1A and 1B) of the linear motor 10 is seen along the perpendicular direction to the movement direction of the slider 20 is referred to as “coil back yoke placement range”. Further, the range in which the four electromagnetic coils 31 are placed is referred to as “coil placement range”.

The coil back yoke 33 is placed to cover the entire outer circumferential surfaces of the four electromagnetic coils 31 so that both ends in the movement direction of the slider 20 may project from the ends of the four electromagnetic coils 31. That is, the coil placement range is a range narrower than the coil back yoke placement range and its entire range is contained in the coil back yoke placement range.

The plural slits S of the coil back yoke 33 are formed over the entire range of the coil placement range (FIG. 2). By forming the slits S in correspondence with the regions in which the electromagnetic coils 31 are arranged, the generation region of the eddy currents may be divided more reliably. Further, the coil back yoke 33 has an integrated configuration in which the whole body is coupled at ends in the width direction (in the horizontal direction of the paper in FIG. 2), and its handleability in the manufacturing process of the linear motor 10 is improved.

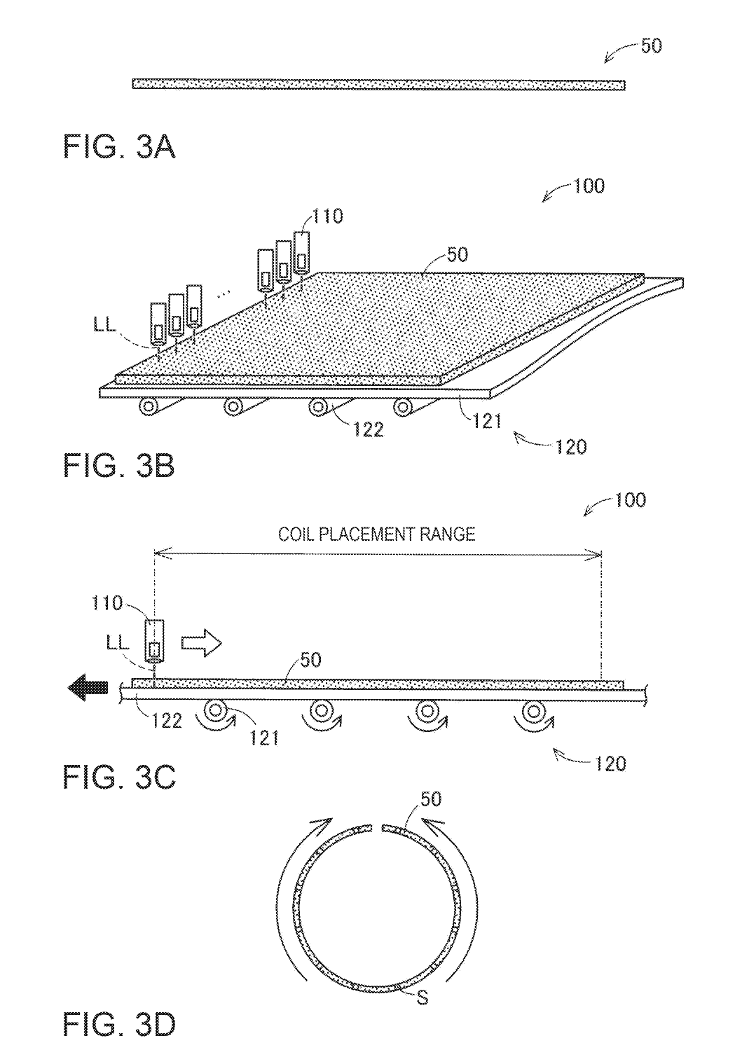

FIGS. 3A to 3D are explanatory diagrams for explanation of a manufacturing process of the coil back yoke 33. FIG. 3A is a schematic diagram showing a preparation step of a steel plate 50 as a base material of the coil back yoke 33 as the first step. At the first step, the steel plate 50 with high magnetic permeability is prepared in a flat state.

FIGS. 3B and 3C are schematic diagrams showing a forming step of the slits S in the steel plate 50 as the second step. FIG. 3B shows a schematic perspective view of a slit forming apparatus 100 for forming the slits S in the steel plate 50, and FIG. 3C shows a schematic side view of the slit forming apparatus 100. In FIGS. 3B and 3C, laser beams LL are shown by broken lines.

The slit forming apparatus 100 includes plural laser output units 110 arranged in a line and a conveyance unit 120 for conveying the steel plate 50. The plural laser output units 110 are arranged in a line in correspondence with the intervals of the slits S formed in the coil back yoke 33 in a direction perpendicular to the conveyance direction of the steel plate 50 by the conveyance unit 120. The conveyance unit 120 includes a conveyance belt 121 on which the steel plate 50 is mounted and plural conveyance rollers 122 that drive the conveyance belt 121 in the conveyance direction of the steel plate 50.

In the slit forming apparatus 100, the conveyance unit 120 conveys the steel plate 50 at a constant speed. Further, the respective laser output units 110 output laser in a range corresponding to the coil placement range while moving along the outer surface of the steel plate 50 in an opposite direction (shown by a white arrow) to the conveyance direction of the steel plate 50 (shown by a black arrow) by the conveyance unit 120. Thereby, the plural parallel slits S along the conveyance direction of the steel plate 50 are formed. The width of each slit S formed in the steel plate 50 may be about 0.05 mm. The width of the slit S is more preferable to be closer to 0 mm.

As described above, at the step, the conveyance direction of the steel plate 50 by the conveyance unit 120 and the movement direction of the respective laser output units 110 are opposite to each other. Thereby, the relative speed of the steel plate 50 to the laser output units 110 is increased and the process time for forming the plural slits S is shortened.

Note that, at the step, the respective slits S may be formed by allowing the respective laser output units 110 to scan the outer surface of the steel plate 50 with the conveyance of the steel plate 50 by the conveyance unit 120 halted. Further, in reverse, the respective slits S may be formed by allowing the conveyance unit 120 to convey the steel plate 50 and executing output of the laser to the steel plate 50 with the positions of the respective laser output units 110 fixed.

FIG. 3D is a schematic diagram showing a step of bending work of the steel plate 50. At the step, the steel plate 50 is bent into a nearly cylindrical shape with the arrangement direction of the slits S as a circumferential direction, and thereby, the coil back yoke 33 is completed. After the step, the coil back yoke 33 is assembled in the linear motor 10. The coil back yoke 33 of the embodiment is not separated into parts, but integrally formed as described above, and thus, the assembly in the linear motor 10 is easy.

As described above, according to the linear motor 10 of the embodiment, the coil back yoke 33 is provided on the outer circumferences of the electromagnetic coils 31, and the magnetic flux leakage in the linear motor 10 is suppressed and the magnetic flux efficiency is improved. Further, in the coil back yoke 33, the plural slits S are formed so that the generation region of eddy currents may be fragmented. Accordingly, the eddy-current generation loss in the linear motor 10 is reduced.

### B. Other Configuration Examples of Embodiment

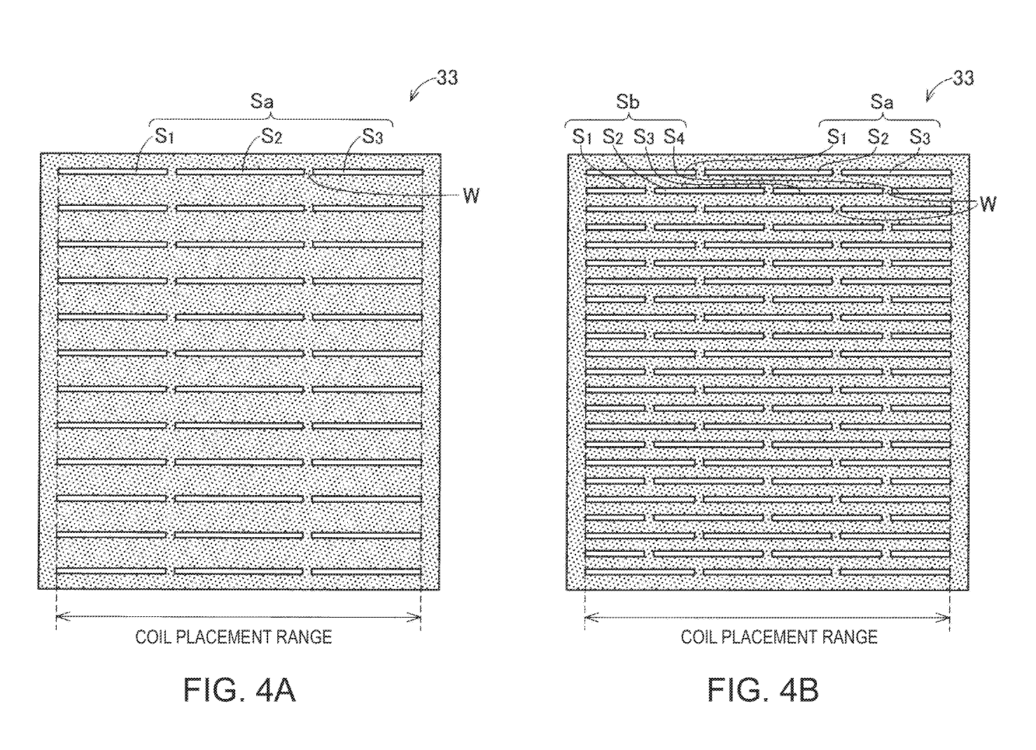

FIGS. 4A and 4B are schematic diagrams showing other configuration examples of plural slits S provided in the coil back yoke 33. FIG. 4A is nearly the same as FIG. 2 except that slits Sa are formed in place of the slits S. Each slit Sa of the configuration example has a configuration in which three slit parts S₁ to S₃ as discontinuous separated penetration grooves are arranged in series. That is, the slits provided in the coil back yoke 33 are not necessarily formed as continuous penetration grooves in line, but may be formed as discontinuous interrupted penetration grooves.

In the configuration example, each slit Sa is separated into the three slit parts S₁ to S₃, however, each slit Sa may be separated into two slit parts S₁ and S₂ or three or more slit parts S₁ to Sₙ (n is a natural number equal to or larger than three).

Here, in the coil back yoke 33 in which the slits Sa separated into the plural slit parts S₁ to S₃ are provided, there are partition walls W connecting the regions sandwiched between the respective slits Sa between the respective slit parts S₁ to S₃. Therefore, by the partition walls W, the stiffness of the coil back yoke 33 is improved, and non-uniform deformation of the widths of the respective slits Sa at deformation work of the coil back yoke 33 such as bending work explained in FIG. 3D is suppressed.

FIG. 4B is nearly the same as FIG. 4A except that slits Sb having four slit parts S₁ to S₄ are provided between the respective slits Sa. That is, in the configuration example, the arrangement period of the slits in the coil back yoke 33 is about a half of that in the configuration example of FIG. 4A and the generation region of eddy currents is further fragmented. Therefore, using the coil back yoke 33 of the configuration example, the eddy-current loss in the linear motor 10 may be further reduced.

Further, in the configuration example, the slits Sa and the slits Sb are formed as the interrupted penetration grooves with different pitches. Thereby, the formation positions of the partition walls W sandwiched between the ends of the respective slits S₁ to S₄ in the respective slits Sb and the formation positions of the partition walls W sandwiched between the ends of the respective slits S₁ to S₃ in the respective slits Sa are offset. That is, as seen along the perpendicular direction relative to the arrangement direction of the respective slits Sa, Sb, the respective partition walls W have discontinuous arrangement configurations. By the configurations, even when the arrangement periods of the respective slits Sa, Sb are fragmented, significant degradation in stiffness of the coil back yoke 33 is suppressed.

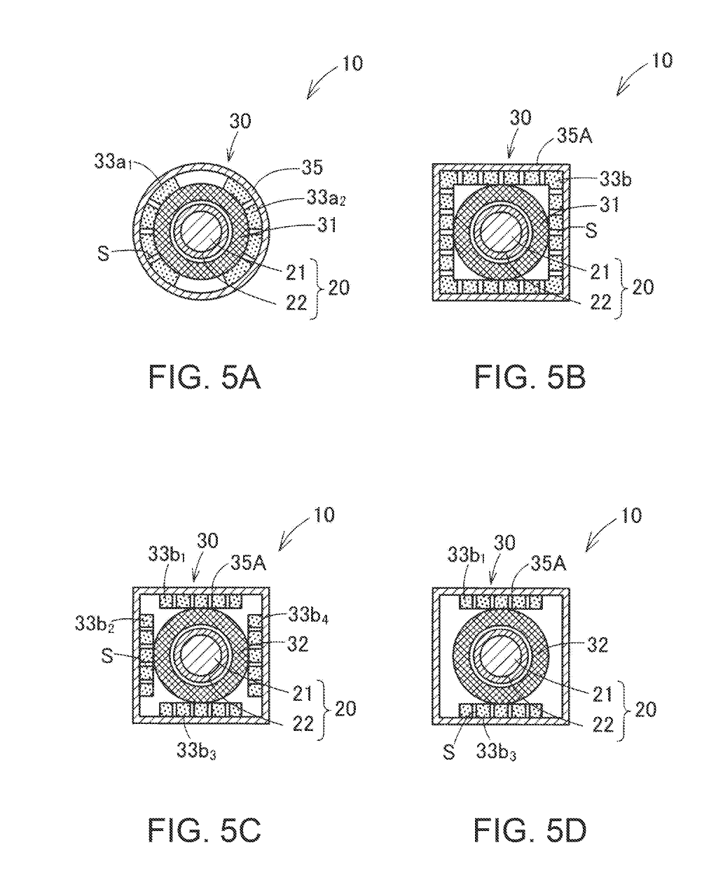

FIGS. 5A to 5D are schematic diagrams showing other configuration examples of the coil back yoke 33 of the embodiment. FIGS. 5A to 5D respectively show schematic sectional views of the linear motor 10 similar to FIG. 1B.

In the configuration example of FIG. 5A, two coil back yokes 33a₁ and 33a₂ are provided in place of the coil back yoke 33 in the linear motor 10. The two coil back yokes 33a₁ and 33a₂ are provided apart from each other in positions opposed to each other with the electromagnetic coils 31 in between on the outer circumferences of the electromagnetic coils 31. In the two coil back yokes 33a₁ and 33a₂, the same plural slits S as those explained in the first embodiment are respectively formed.

That is, in the configuration example, regions covered by one of the two coil back yokes 33a₁ and 33a₂ and regions not covered are formed on the outer circumferences of the electromagnetic coils 31. In the configuration, the magnetic efficiency of the linear motor 10 may be also improved by the coil back yokes 33a₁ and 33a₂. Further, the eddy-current loss in the linear motor 10 may be reduced by the plural slits S formed in the respective coil back yokes 33a₁ and 33a₂.

In the configuration example of FIG. 5B, the linear motor 10 has a casing 35A in a nearly square cylinder shape in place of the casing 35 in the nearly circular cylinder shape. Further, in the configuration example, the linear motor 10 has a coil back yoke 33b formed in a nearly square cylinder shape conforming with the shape of the casing 35A in place of the coil back yoke 33 in the nearly circular cylinder shape.

Note that, in the configuration example, the coil back yoke 33b is placed to cover the entire inner wall surface of the casing 35A and has an air gap between the outer circumferences of the electromagnetic coils 31 and itself. Further, the coil back yoke 33b of the configuration example has the same plural slits S as those explained in the embodiment.

In the configuration, the magnetic efficiency of the linear motor 10 may be also improved by the coil back yoke 33b. Further, the eddy-current loss in the linear motor 10 may be reduced by the plural slits S formed in the coil back yoke 33b.

FIG. 5C is nearly the same as FIG. 5B except that four coil back yokes 33b₁ to 33b₄ are provided separately with respect to each of the four inner wall surfaces of the casing 35A in place of the coil back yoke 33b. Further, FIG. 5D is nearly the same as FIG. 5C except that the coil back yokes 33b₂ and 33b₄ opposed to each other with the electromagnetic coils 31 in between are omitted.

In the configuration, the magnetic efficiency of the linear motor 10 maybe also improved, and the eddy-current loss in the linear motor 10 may be reduced. In any one of the configuration examples in FIGS. 5A to 5D, plural intermitted slits like the slits Sa, Sb explained in FIGS. 4A and 4B may be provided in place of the slits S. Note that, in any one of the configuration examples in FIGS. 5A to 5D, the uniformity of the magnetic flux in the linear motor 10 is lower than that in the embodiment. Therefore, the configuration of the embodiment is more preferable than the configuration examples in FIGS. 5A to 5D.

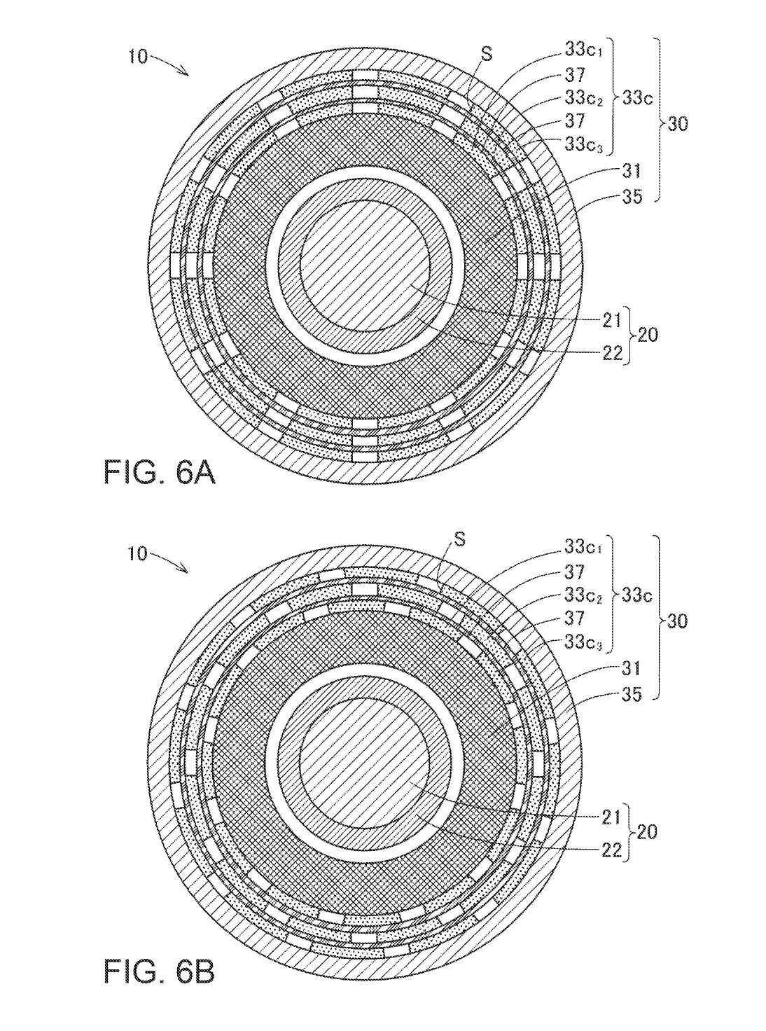

FIG. 6A is a schematic diagram showing another configuration example of the coil back yoke 33 of the embodiment. FIG. 6A is nearly the same as FIG. 1B except that a coil back yoke layer 33c in which plural coil back yokes 33c₁ to 33c₃ are stacked is provided in place of the coil back yoke 33.

The coil back yoke layer 33c of the configuration example has a configuration in which the first to third coil back yokes 33c₁ to 33c₃ formed in nearly circular cylindrical shapes having different diameters from one another are concentrically provided in a nested structure. Further, insulating layers 37 having adhesiveness are respectively provided between the first and second coil back yokes 33c₁ and 33c₂ and the second and third coil back yokes 33c₂ and 33c₃. By the insulating layers 37, the respective coil back yokes 33c₁ to 33c₃ are integrated.

In the respective coil back yokes 33c₁ to 33c₃, the same plural parallel slits S as those explained in FIG. 2 are provided like the coil back yoke 33 of the embodiment. In the example of FIG. 6A, the respective slits S of the respective coil back yokes 33c₁ to 33c₃ are formed to be radially arranged with respect to the center axis of the linear motor 10 when the linear motor 10 is formed.

As described above, by stacking the plural coil back yokes 33c₁ to 33c₃, the magnetic flux leakage may be further suppressed and the drive efficiency in the linear motor 10 is improved. Note that, in the example of FIG. 6A, the coil back yoke layer 33c has a three-layer structure in which the first to third coil back yokes 33c₁ to 33c₃ are stacked, however, the coil back yoke layer 33c may have a two-layer structure, or a multilayer structure in which plural coil back yokes 33c₁ to 33cₘ (m is a natural number equal to or larger than four) are stacked. Further, the insulating layers 37 may be omitted.

FIG. 6B is a schematic diagram showing another configuration example of the coil back yoke layer 33c explained in FIG. 6A. FIG. 6B is nearly the same as FIG. 6A except that the positions of the respective slits S formed in the respective coil back yokes 33c₁ to 33c₃ are offset with respect to each other. As shown in the drawing, the positions of the respective slits S in the respective coil back yokes 33c₁ to 33c₃ may not be provided in positions overlapping each other.

In either of the configuration examples in FIGS. 6A and 6B, the slits S having different slit widths or slits S in different numbers may be provided in the respective coil back yokes 33c₁ to 33c₃. Further, plural intermittent slits Sa, Sb as explained in FIGS. 4A and 4B may be provided in the respective coil back yokes 33c₁ to 33c₃.

### C. Modified Examples

The invention is not limited to the above described examples and embodiments, but can be implemented in various forms without departing from the scope of the invention. For example, the following modifications can be made.

### C1. Modified Example 1

In the embodiment, the respective slits S are arranged nearly uniformly in the coil back yoke 33. However, it is not necessarily that the respective slits S are arranged nearly uniformly in the coil back yoke 33. Note that it is preferable that the respective slits S are arranged nearly uniformly in the coil back yoke 33 because the uniformity of the magnetic flux in the linear motor 10 is kept.

### C2. Modified Example 2

In the embodiment, the respective slits S are formed in a range equal to the coil placement range. However, the respective slits S may be formed beyond the coil placement range or formed only in a part of the coil placement range.

### C3. Modified Example 3

In the embodiment, the respective slits S of the coil back yoke 33 are formed as penetration grooves in linear shapes. However, the respective slits S may be formed in curved shapes. It is only necessary that the respective slits S are formed so that the generation region of eddy currents in the coil back yoke 33 may be fragmented when the coil back yoke 33 is assembled in the linear motor 10.

### C4. Modified Example 4

In the embodiment, the linear motor 10 has the four electromagnetic coils 31. However, the linear motor 10 may further have plural electromagnetic coils 31. Further, the four electromagnetic coils 31 of the linear motor 10 are divided into the electromagnetic coils 31a, 31b for two phases, however, the linear motor 10 may further have electromagnetic coils for plural phases (e.g., three phases). That is, the linear motor 10 is not limited to the configuration of the embodiment. It is only necessary that the linear motor 10 includes the slider 20 having the magnet row 211 and the stator 30 in which the electromagnetic coils 31 for plural phases inserted into the slider 20 at the inner circumference side are arranged along the movement direction of the slider 20.

### C5. Modified Example 5

In the embodiment, since the ends of the respective slits S of the coil back yoke 33 are closed, separation of the part of the coil back yoke 33 is suppressed and the coil back yoke 33 has the integrated configuration. However, it is only necessary that the respective slits S of the coil back yoke 33 are closed at least one ends. Also, in the configuration, separation of the part of the coil back yoke 33 may be suppressed and the handle ability of the coil back yoke 33 may be improved.

This application claims priority to Japanese Patent Application No. 2010-236331 filed on Oct. 21, 2010. The entire disclosure of Japanese Patent Application No. 2010-236331 is hereby incorporated herein by reference.

What is claimed is:

1. A linear motor comprising:
a slider unit having a magnet row in which plural permanent magnets are arranged in series so that the same poles are opposed to each other and moving in an arrangement direction of the magnet row by electromagnetic force;
a stator unit in which the slider unit is inserted at an inner circumference side and electromagnetic coils for plural phases that receive supply of drive currents at different phases with respect to each phase are arranged along a movement direction of the slider unit; and
a back yoke provided at an outer circumference side of the electromagnetic coils for plural phases in the stator unit,
wherein plural slits along the movement direction of the slider unit for dividing a generation region of eddy currents into plural parts are formed in the back yoke.

2. The linear motor according to claim 1, wherein the plural slits are respectively formed over the entire region in which the electromagnetic coils for plural phases are arranged when the stator unit is seen along a direction perpendicular to the movement direction of the slider unit.

3. A back yoke used for a linear motor including a slider unit having a magnet row in which plural permanent magnets are arranged in series so that the same poles are opposed to each other and moving in an arrangement direction of the magnet row by electromagnetic force, and a stator unit in which the slider unit is inserted at an inner circumference side and electromagnetic coils for plural phases that receive supply of drive currents at different phases with respect to each phase are arranged along a movement direction of the slider unit,
the back yoke provided at an outer circumference side of the electromagnetic coils for plural phases in the stator unit, and having plural slits formed along the movement direction of the slider unit for dividing a generation region of eddy currents into plural parts.

4. A manufacturing method of a back yoke provided at an outer circumference side of electromagnetic coils for plural phases, used for a linear motor including a slider unit having a magnet row in which plural permanent magnets are arranged in series so that the same poles are opposed to each other and moving in an arrangement direction of the magnet row by electromagnetic force, and a stator unit in which the slider unit is inserted at an inner circumference side and the electromagnetic coils for plural phases that receive supply of drive currents at different phases with respect to each phase are arranged along a movement direction of the slider unit, the method comprising:
(a) preparing a plate-like magnetic material member as a base material of the back yoke; and
(b) forming plural slits that divide a region where eddy currents are generated when the linear motor is driven by scanning an outer surface of the magnetic material member along a direction corresponding to the movement direction of the slider unit using a laser beam.
